(19) United States
(12) Patent Application Publication
(10) Pub. No.: US 2010/0061041 A1
(43) Pub. Date: Mar. 11, 2010

(54) ELECTRONIC DEVICE

(75) Inventor: Sheng-Wei CHEN, Chung Ho City (TW)

Correspondence Address: Workman Nydegger;1000 Eagle Gate Tower, 60 East South Temple, Salt Lake City, UT, 84111, US

(73) Assignee: AmTRAN TECHNOLOGY CO., LTD, Chung Ho City (TW)

(21) Appl. No.: 12/243,716

(22) Filed: Oct. 1, 2008

(30) Foreign Application Priority Data
Sep. 10, 2008 (TW) 097216367

(51) Int. Cl. F16M 13/00

(52) U.S. Cl. 361/679.01; 248/550

(57) ABSTRACT

An electronic device includes a base unit, a display unit, at least one sensor, and at least one rotary motor. The display unit is movably connected to the base unit. The sensor is located on the display unit, for receiving and transmitting a signal. The rotary motor is located in the base unit, for driving the display unit to rotate with the base unit as a support according to the signal. The sensor receives a user instruction to control the rotation direction and angle of the display unit, so as to avoid manual adjustment or save the cost of purchasing components like a swivel platform.

### CROSS-REFERENCE TO RELATED APPLICATIONS

This non-provisional application claims priority under 35 U.S.C. §119(a) on Patent Application No(s). 097216367 filed in Taiwan, R.O.C. on Sep. 10, 2008 the entire contents of which are hereby incorporated by reference.

### BACKGROUND OF THE INVENTION

1. Field of Invention

The present invention relates to an electronic device, and more particularly to an electronic device with a sensor.

2. Related Art

Generally, for large-sized electronic devices like televisions, users wish to adjust the side-to-side rotation directions and up-and-down tilt angles, so as to select the most comfortable viewing angle. However, in order to adjust the angle of the television, the user has to walk to the television to push or move it. Besides, as large-sized televisions are becoming more and more popular to satisfy the watching pleasure, their volume and weight are continuously growing. Therefore, even for an adult male, it is not easy to push or move a television to adjust its rotation or tilt angle, let alone women, children, or the old.

In order to facilitate the rotation of the angle of the television, some manufacturer provides a swivel mount or electric platform, such that the television can be placed on the swivel mount or electric platform to have its angle adjusted. However, the swivel mount or electric platform is very expensive, and the expense of the user will be increased.

### SUMMARY OF THE INVENTION

Accordingly, the present invention is directed to an electronic device, so as to solve the problem that it is difficult to adjust the angle of the display due to its excessively high weight or large size, and meanwhile avoid additional expense for facilitating the rotation of the display.

The present invention provides an electronic device, which includes a base unit, a display unit, at least one sensor, and at least one rotary motor. The display unit is movably connected to the base unit. The at least one sensor is located on the display unit, for receiving and transmitting a signal. The at least one rotary motor is located in the base unit, for driving the display unit to rotate with the base unit as a support according to the signal.

The signal is a wireless signal or touch signal. The at least one sensor is an infrared receiver for receiving and transmitting an infrared signal. Definitely, the sensor may also be a radio frequency (RF) receiver for receiving and transmitting an RF signal, or a touch sensor for being touched to receive and transmit a touch signal.

The at least one sensor is located on the display unit and disposed in a rotation direction of the display unit, for controlling the at least one rotary motor to drive the display unit to rotate in the rotation direction after receiving and transmitting the touch signal.

The electronic device further includes a signal transmitter for transmitting the signal.

The display unit includes a screen, and the at least one sensor is disposed on at least one of one side of the screen and one side surface of the display unit. The at least one rotary motor is located in the base unit, for controlling the display unit to perform at least one of a horizontal rotation and a vertical rotation with the base unit as a support, and a rotation angle thereof is in a range of 0° to 180°. The vertical rotation includes rotating about a first direction vertical to the screen as a rotation axis, and rotating about a second direction parallel to the screen as a rotation axis. The display unit may rotate at intervals or continuously with the base unit as a support.

The electronic device further includes a microprocessor, electrically connected to the at least one sensor and the at least one rotary motor, for receiving the signal and controlling the at least one rotary motor to drive the display unit to perform at least one rotation action. The base unit is used for supporting the display unit on a horizontal or vertical plane.

The present invention provides another electronic device, which includes a base unit, an electronic member, at least one touch sensor, and at least one rotary motor. The electronic member is movably connected to the base unit. The at least one touch sensor is located on a surface of the electronic member, for being touched to generate a user instruction. The at least one rotary motor is located in the base unit, for driving the electronic member to rotate with the base unit as a support in a single direction according to the user instruction.

The at least one sensor is located on the surface of the electronic member and disposed in a rotation direction of the electronic member, for controlling the at least one rotary motor to drive the electronic member to rotate in the rotation direction after receiving and transmitting the user instruction.

The electronic member includes a screen, and is disposed on at least one of one side of the screen and on one side surface of the electronic member. The at least one rotary motor is located in the base unit, for controlling the electronic member to perform at least one of a horizontal rotation and a vertical rotation with the base unit as a support, and a rotation angle thereof is in a range of 0° to 180°. The vertical rotation includes rotating about a first direction vertical to the screen as a rotation axis, and rotating about a second direction parallel to the screen as a rotation axis. The electronic member may rotate at intervals or continuously with the base unit as a support. In addition, the electronic member may be a display unit.

The electronic device further includes a microprocessor, electrically connected to the at least one touch sensor and the at least one rotary motor, for receiving the user instruction and controlling the at least one rotary motor to drive the display unit to perform at least one rotation action. The base unit is used for supporting the display unit on a horizontal or vertical plane. The rotation action includes that when the touch sensor receives the user instruction for the first time, the rotary motor drives the electronic member to rotate in a first direction; and when the touch sensor receives the user instruction for the second time, the rotary motor drives the electronic member to rotate in a second direction opposite to the first direction.

In view of the above, an electronic device of the present invention includes a base unit, a display unit, at least one touch sensor, and at least one rotary motor. The at least one touch sensor is disposed on the display unit, and the at least one rotary motor is disposed on the base unit. On receiving a user instruction or signal, the touch sensor on the display unit controls the rotary motor to drive the display unit to perform horizontal rotation or vertical rotation with the base unit as a support. Therefore, the angle of the display unit can be easily adjusted, and meanwhile, the additional expense for purchasing the swivel mount can be saved to further reduce the cost.

### BRIEF DESCRIPTION OF THE DRAWINGS

The present invention will become more fully understood from the detailed description given herein below for illustration only, and thus are not limitative of the present invention, and wherein:

FIG. 1A is a schematic front view of a first embodiment of the present invention;

FIG. 1B is a schematic back view of the first embodiment of the present invention;

FIG. 2 is a schematic view illustrating a horizontal rotation in the first embodiment;

FIG. 3 is a schematic view illustrating a vertical rotation in the first embodiment;

FIG. 4 is a schematic view illustrating another vertical rotation in the first embodiment;

FIG. 5 is a schematic view of a second embodiment of the present invention;

FIG. 6 is a schematic view illustrating a horizontal rotation in the second embodiment;

FIG. 7 is a schematic view illustrating a vertical rotation in the second embodiment; and

FIG. 8 is a schematic view illustrating another vertical rotation in the second embodiment.

### DETAILED DESCRIPTION OF THE INVENTION

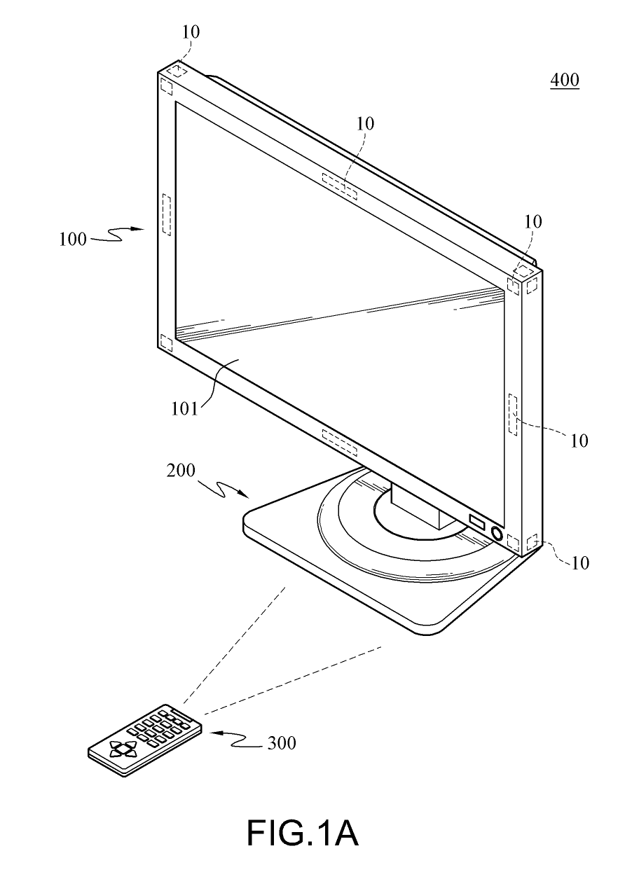

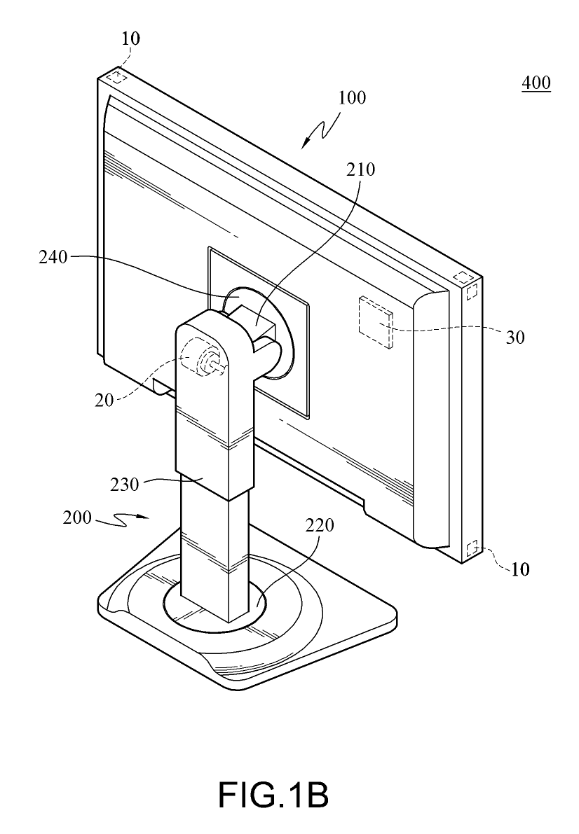

Referring to FIGS. 1A and 1B, FIG. 1A is a schematic front view of a first embodiment of the present invention, and FIG. 1B is a schematic back view of the first embodiment of the present invention. The electronic device 400 includes a display unit 100, a base unit 200, at least one sensor 10, at least one rotary motor 20, and a microprocessor 30.

The display unit 100 is movably connected to the base unit 200. The movable connection is fulfilled through movable or rotational connection structures like a pivoting structure 210, a first rotational structure 220, and a second rotational structure 240. The base unit 200 includes a telescopic stand 230. When the display unit 100 is movably connected to the base unit 200, the telescopic stand 230 may extend or retract to adjust the ground clearance of the display unit 100. The display unit 100 includes a screen 101. The base unit 200 may support the display unit 100 on a horizontal plane or on a vertical plane, i.e., the base unit 200 is hung to support the display unit 100 against the wall. The relative positions of the first and second rotational structures 220, 240, the pivoting structure 210, and the telescopic stand 230 in the base unit 200 are not limited to this embodiment. Further, in this embodiment, the display unit 100 can be replaced by an electronic member.

The sensor 10 is located on the display unit 100, for receiving and transmitting a signal or a user instruction. The sensor 10 may also be mounted in the display unit 100 or the base 200, or mounted on the surface of the display unit 100 or the surface of the base 200. Definitely, the sensor 10 may also be mounted on one side of the screen 101 or on one side surface of the display unit 100. In addition, the sensor 10 may be individually disposed on the display unit 100 or disposed on the display unit 100 with a plural number. The sensor 10 is a signal receiver (for example, an infrared receiver, RF receiver, or wireless network receiver), for receiving or transmitting a wireless signal such as an infrared signal, RF signal, or wireless network signal. The RF signal is, for example, a blue-tooth signal.

The rotary motor 20 is located in the base unit 200, for driving the display unit 100 to perform at least one rotation action with the base unit 200 as a support or rotation axis according to the signal. The rotation is, for example, a horizontal or vertical rotation, and the rotation angle is in a range of 0° to 180°. After receiving the signal, the rotary motor 20 keeps on (continues) driving the display unit 100 to rotate till receiving the next signal. Or, on receiving the signal, the rotary motor 20 drives the display unit 100 to rotate at intervals, i.e., every time a signal is received, the display unit 100 rotates by an angle in a range of 5° to 30°. Moreover, if the signal is continuously received, the rotary motor 20 keeps on (continues) driving the rotation display unit 100 till the signal stops.

In addition, the rotation action includes that when the sensor 10 receives a user instruction for the first time, the rotary motor 20 drives the display unit 100 to rotate in a first direction, and when the sensor 10 receives a user instruction for the second time, the rotary motor 20 drives the display unit 100 to rotate in a second direction. The second direction is opposite to the first direction.

In this embodiment, the electronic device 400 further includes a microprocessor 30. The microprocessor 30 is electrically connected to the at least one sensor 10 and at least one rotary motor 20. The microprocessor 30 is used for receiving a signal and controlling the at least one rotary motor 20 to drive the display unit 100 to perform at least one rotation action.

The electronic device further includes a signal transmitter 300. The signal transmitter 300 is used for transmitting a wireless signal corresponding to the sensor 10, and the signal is received by the sensor 10. The wireless signal contains a control instruction for controlling the electronic device 400 to perform horizontal rotation or vertical rotation with the base unit 200 as a support. The signal transmitter 300 may be a remote-control device having an infrared transmitter, RF transmitter, or wireless network transmitter. The electronic device 400 may be a display, television, or projector.

On receiving the wireless signal from the signal transmitter 300, the sensor 10 mounted on the display unit 100 first transmits the wireless signal to the microprocessor 30. After resolving the wireless signal, the microprocessor 30 controls the rotary motor 20 to drive the display unit 100 to perform an action corresponding to the instruction in the wireless signal, such that the display unit 100 performs the horizontal rotation or vertical rotation with the base unit 200 as a support or rotation axis (i.e., the display unit 100 rotates about the base unit 200 as a support from side to side or up and down, or the display unit 100 spins about the joint with the base unit 200 as a rotation axis).

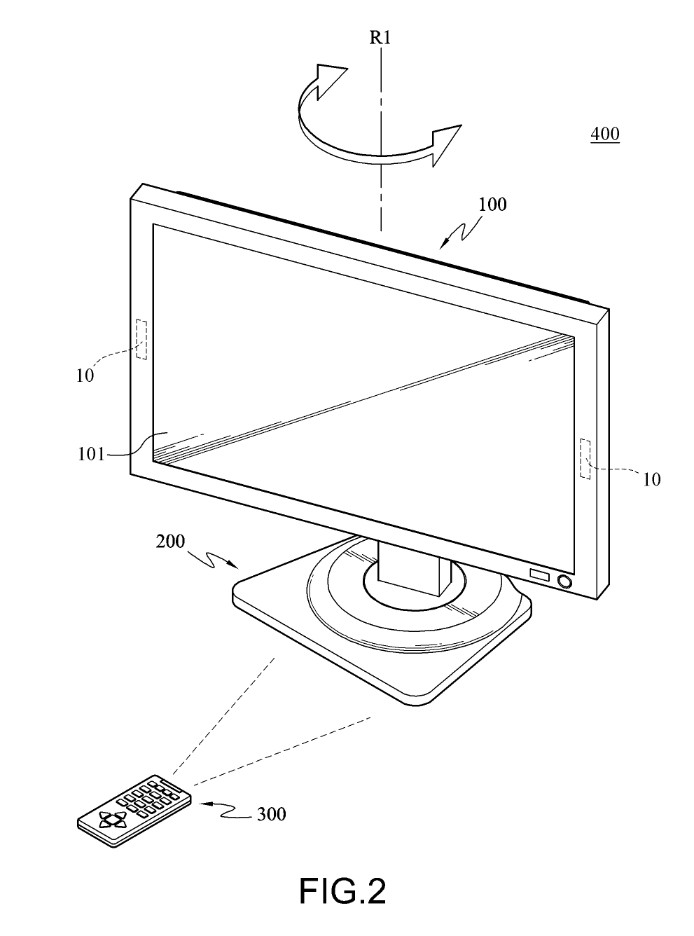

FIG. 2 is a schematic view illustrating a horizontal rotation in the first embodiment. The specific members may refer to FIGS. 1A and 1B. The rotary motor 20 is located in the base unit 200, and the first rotational structure 220 is movably connected to the display unit 100 and the base unit 200. The rotary motor 20 controls the first rotational structure 220 to drive the display unit 100 to perform a horizontal rotation with the base unit 200 as a support (i.e., the telescopic stand 230) or a rotation axis R1, i.e., to perform the horizontal rotation about the base unit 200, and the rotation angle thereof is in a range of 0° to 180° or 0° to 90°. Further, as shown in the figure, the rotation axis R1 is parallel to the telescopic stand 230.

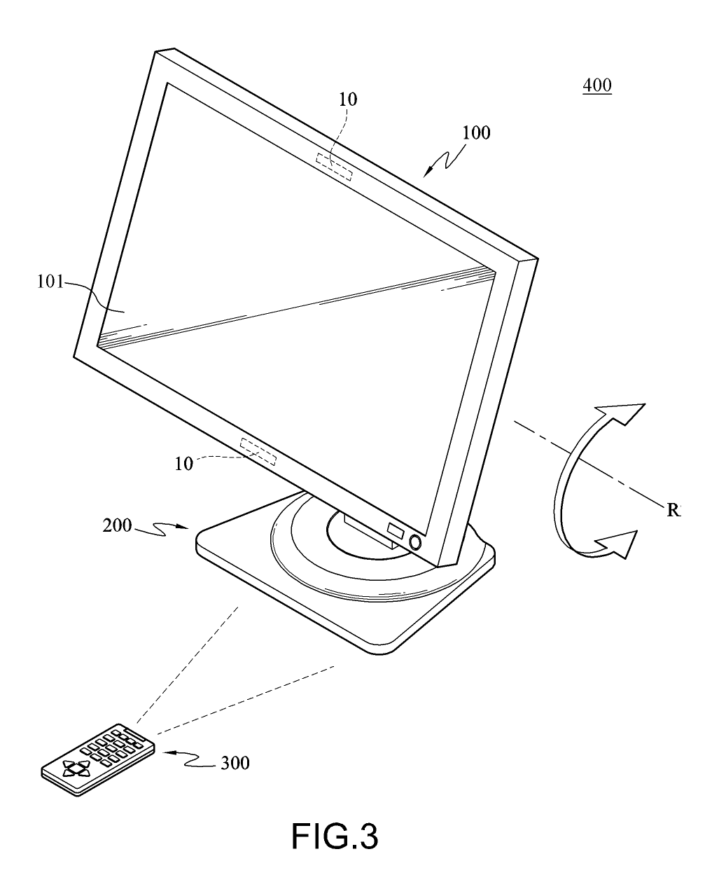

FIG. 3 is a schematic view illustrating a vertical rotation in the first embodiment. The rotary motor 20 is located in the base unit 200, and the pivoting structure 210 is movably connected to the display unit 100 and the base unit 200. The rotary motor 20 controls the pivoting structure 210 to drive the display unit 100 to perform the vertical rotation with the pivoting structure 210 or the base unit 200 as a support (i.e., the telescopic stand 230), and the rotation angle thereof is in a range of 0° to 90° or 0° to 45°. In other embodiments, the vertical rotation may even be performed in a range of 0° to 180°. In this figure, the vertical rotation is carried out with a second direction parallel to the screen 101 as a rotation axis R2. That is, the rotary motor 20 controls the display unit 100 to rotate about the second direction parallel to the screen 101 as the rotation axis R2.

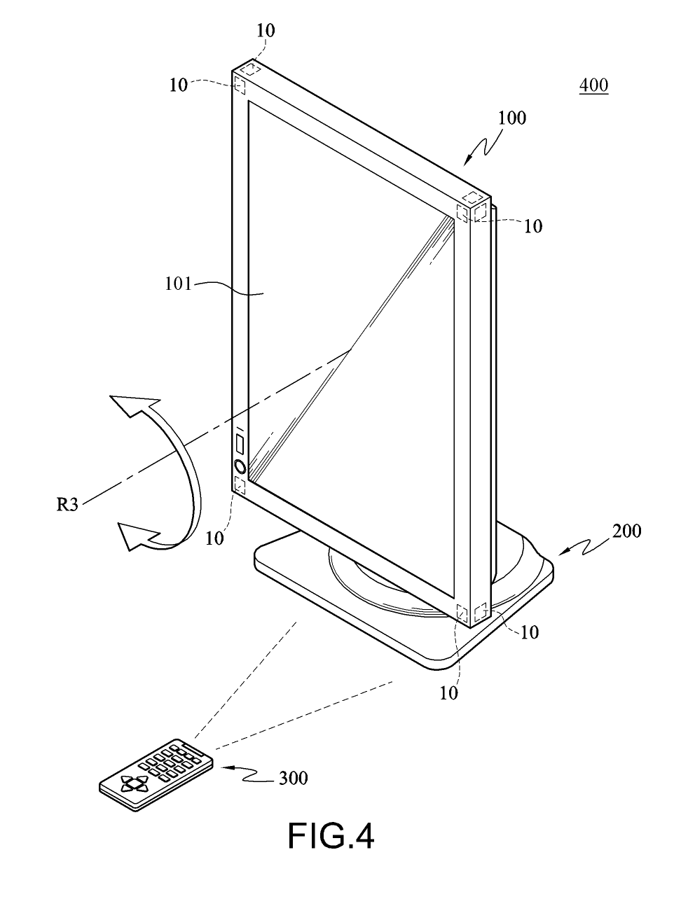

FIG. 4 is a schematic view illustrating another vertical rotation in the first embodiment. The rotary motor 20 is located in the base unit 200. The first rotational structure 220 and the second rotational structure 240 are movably connected to the display unit 100 and the base unit 200. The rotary motor 20 controls the second rotational structure 240 to drive the display unit 100 to perform the vertical rotation with the base unit 200 as a support (i.e., the telescopic stand 230). In this figure, the display unit 100 rotates about a first direction vertical to the screen 101 as a rotation axis R3. The rotation direction may be clockwise or anticlockwise. The rotation angle is in a range of 0° to 180° or 0° to 90°.

This embodiment is applicable to a display or television. The television (i.e., the electronic device 400) includes a display unit (i.e., the display unit 100). The display unit, movably connected to the base unit (i.e., the base unit 200), includes a screen (i.e., the screen 101). At least one signal receiver (i.e., the sensor 10) is embedded in the housing or the surface of the screen, and a rotary motor (i.e., the rotary motor 20) is disposed in the base unit. On receiving a wireless signal or user instruction from a remote control (i.e., the signal transmitter 300), the signal receiver on the screen housing transmits the wireless signal or user instruction to a microprocessor (i.e., the microprocessor 30) in the television, and thus the microprocessor controls the rotary motor to operate. The rotary motor drives the screen to perform horizontal rotation or vertical rotation with the base unit as a support. Therefore, the angle of the television can be easily adjusted through the electronic device, and meanwhile, the additional expense for purchasing the swivel mount can be saved to further reduce the cost.

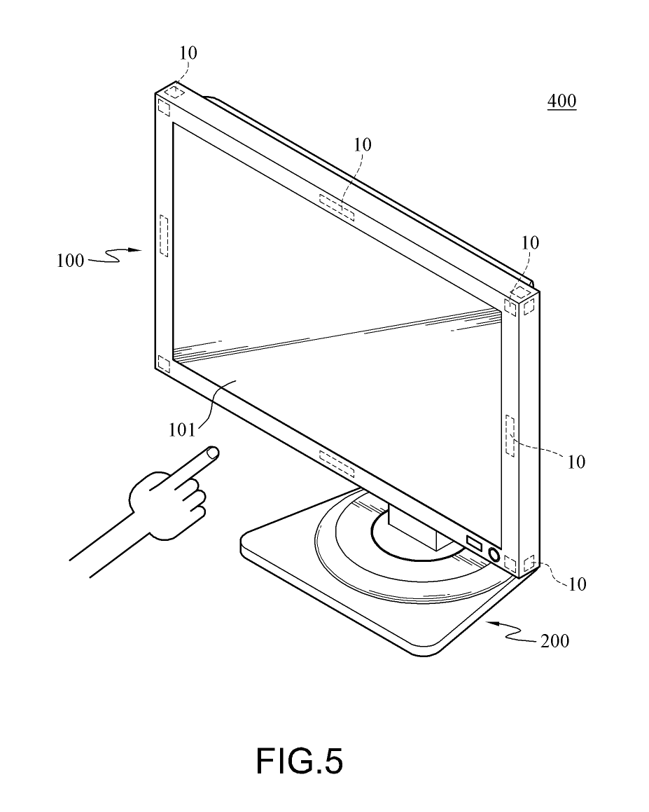

FIG. 5 is a schematic view of a second embodiment of the present invention. The specific members may refer to FIGS. 1A and 1B. This embodiment is similar to the first embodiment. This embodiment is mainly characterized in that the sensor 10 is located on the surface of the display unit 100 and in a rotation direction of the display unit 100. After the sensor 10 receives and transmits a signal, the rotary motor 20 drives the display unit 100 to rotate in the rotation direction.

In this embodiment, the sensor 10 is a touch sensor (for example, a capacitive sensor or resistive sensor). The sensor 10 is triggered by touch to receive or generate a touch signal (user instruction) and then transmit the touch signal. The sensor 10 can be directly touched by hand or by other objects like a touch pen so as to generate a touch signal.

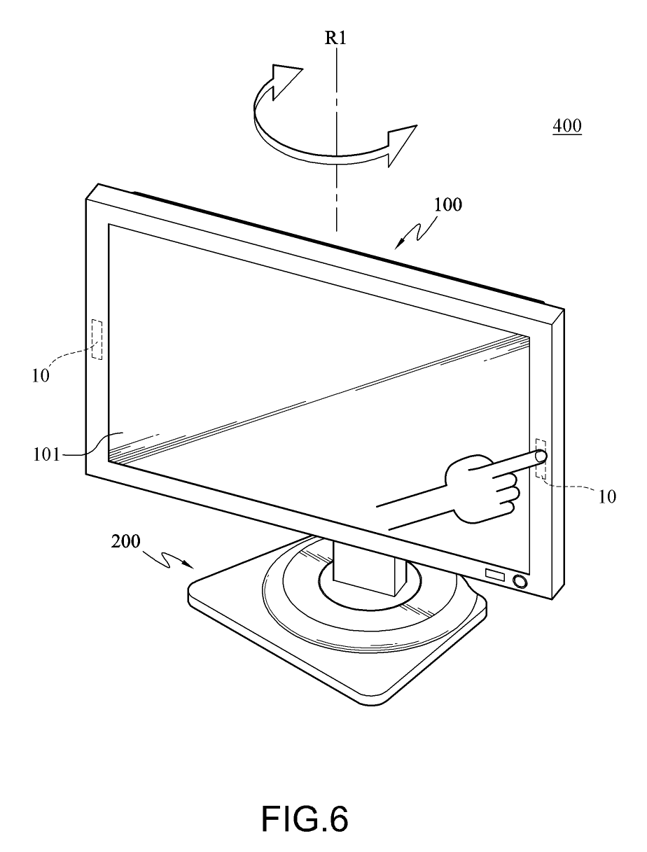

In this embodiment, the display unit 100 is regarded as an electronic member or can be replaced by other electronic members. FIG. 6 is a schematic view illustrating a horizontal rotation in the second embodiment. A plurality of sensors 10 is disposed on the periphery of the screen 101 of the display unit 100. The sensors 10 can be mounted on one side of the screen 101 or respectively on the left and right sides of the screen 101, and the first rotational structure 220 is movably connected to the display unit 100 and the base 200. When the user touches the sensor 10 on the left or right side of the display unit 100 by hand or by other objects, the sensor 10 receives the user instruction to generate and transmit a touch signal to the microprocessor 30, and then the microprocessor 30 controls the rotary motor 20 to operate. The rotary motor 20 controls the first rotational structure 220 to drive the display unit 100 to perform the horizontal rotation with the base unit 200 as a support (i.e., the telescopic stand 230), and the rotation angle thereof is in a range of 0° to 180° or 0° to 90°. In this figure, the base unit 200 can be regarded as a rotation axis R1. That is, the rotary motor 20 controls the display unit 100 to perform the horizontal rotation about the base unit 200 as a rotation axis R1. For example, when the user touches the sensor 10 on the right side of the screen 101 by hand (as shown in FIG. 6), the display unit 100 rotates about the base unit 200 as a rotation axis with its right side turning to the right back and its left side turning to the front (i.e., to rotate anticlockwise). On the contrary, when the user presses or touches the sensor 10 on the left side of the screen 101 by hand or other objects, the display unit 100 rotates clockwise about the base unit 200 as a rotation axis.

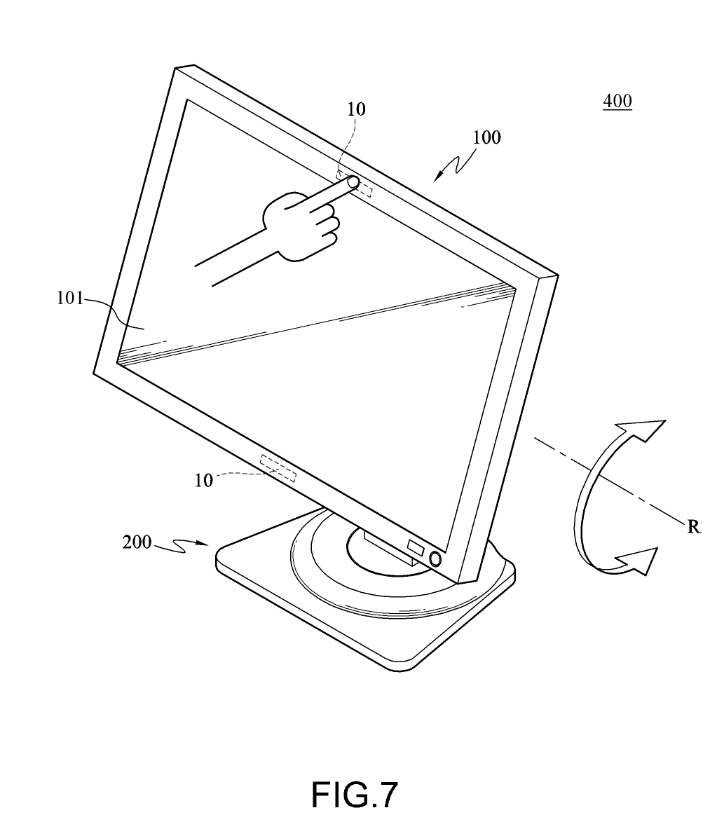

FIG. 7 is a schematic view illustrating a vertical rotation in the second embodiment. The sensors 10 are disposed on the upper and lower sides of the screen 101, and the pivoting structure 210 is movably connected to the display unit 100 and the base unit 200. When the user touches the sensor 10 on the upper or lower side of the screen 101 by hand or by other objects, the sensor 10 receives a user instruction to generate and transmit a touch signal to the microprocessor 30, and then the microprocessor 30 controls the rotary motor 20 to operate. The rotary motor 20 controls the pivoting structure 210 to drive the display unit 100 to perform vertical rotation with the base unit 200 as a support (i.e., the telescopic stand 230). The display unit 100 rotates about a second direction parallel to the screen 101 as a rotation axis R2, and the rotation angle thereof is in a range of 0° to 90° or 0° to 45°. However, in other embodiments, the rotation angle may also be 0° to 180°. For example, when the user touches or presses the sensor 10 on the upper side of the screen 101 by hand, the rotary motor 20 receives the user instruction to transmit a touch signal, so as to drive the upper side of the display unit 100 to tilt backward (as shown in FIG. 7). On the contrary, if the sensor 10 on the lower side of the screen 101 is touched, the lower side of the display unit 100 will tilt backward.

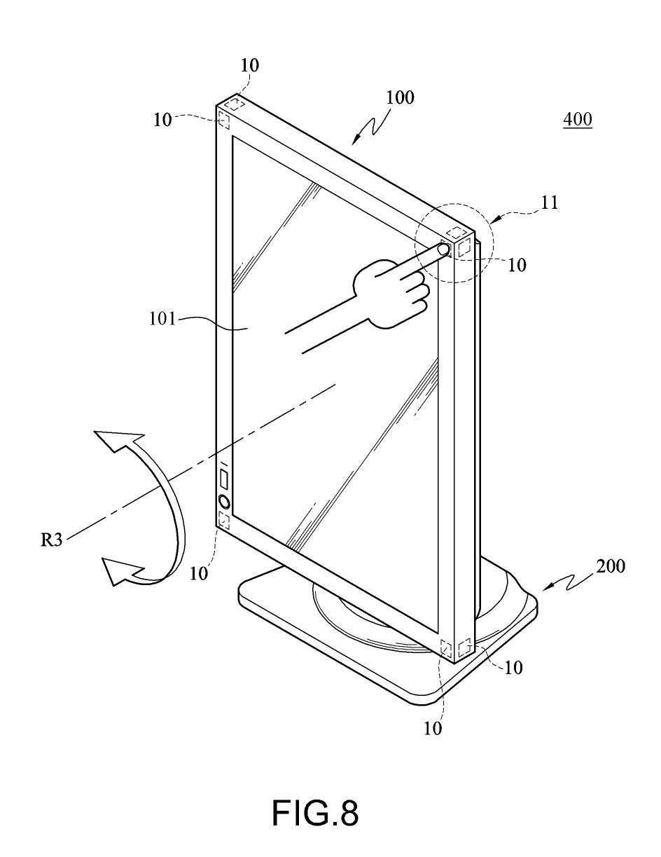

FIG. 8 is a schematic view illustrating another vertical rotation in the second embodiment. The sensor 10 may be disposed at a corner or edge of one side of the screen 101 (for example, the region 11 in the figure), or on one side surface of the display unit 100. The second rotational structure 240 is movably connected to the display unit 100 and the base unit 200. When the user touches the sensor 10 at a corner of one side of the screen 101 or the sensor 10 on one side surface of the display unit 100 by hand or by other objects, the sensor 10 receives and transmits a touch signal to the microprocessor 30, and then the microprocessor 30 controls the rotary motor 20 to operate. The rotary motor 20 controls the second rotational structure 240 to drive the display unit 100 to perform vertical rotation with the base unit 200 as a support (i.e., the telescopic stand 230). In this figure, the display unit 100 rotates about a first direction vertical to the screen 101 as a rotation axis R3. The rotation direction may be clockwise or anticlockwise (indicated by the arrow in the figure). The rotation angle is in a range of 0° to 180° or 0° to 90°.

In addition, the sensor 10 may also be mounted at a top right corner, top left corner, bottom right corner, or bottom left corner of one side of the screen 101, or mounted on one side surface of the display unit 100 (electronic member). In this embodiment, the electronic device 400 includes two or more sensors 10 respectively disposed on different positions of the display unit 100, and the rotation direction of the display unit 100 is set corresponding to the sensor 10. For example, when the user touches the sensor 10 mounted on the top right corner of one side of the screen 101, the display unit 100 rotates clockwise, and when the user touches the sensor 10 mounted on the top left corner of one side of the screen 101, the display unit 100 rotates anticlockwise.

Definitely, the display unit 100 may only have one sensor 10 for receiving vertical rotation instructions. When the sensor 10 is touched, the display unit 100 merely performs the vertical rotation in a particular direction. In other embodiments, though only one sensor 10 for receiving vertical rotation instructions is disposed on the display unit 100, the sensor may generate two types of signals capable of driving the display unit 100 to rotate in opposite directions. For example, if the display unit 100 is horizontally disposed at first, as shown in FIG. 5, when the sensor 10 is touched, the display unit 100 rotates clockwise by 90° about the rotation axis R3, as shown in FIG. 8. When the sensor 10 is touched again, the display unit 100 rotates anticlockwise by 90° about the rotation axis R3, i.e., returning to the original position in FIG. 5.

Similarly, each rotation angle in this embodiment can be controlled by touching the sensor 10. For example, when the sensor 10 is continuously touched (i.e., the sensor 10 keeps on receiving a user instruction), the rotary motor 20 drives the display unit 100 to rotate till the sensor 10 is no longer touched (i.e., the sensor 10 stops receiving any user instruction). However, in other embodiments, whenever the sensor 10 receives a single user instruction and is touched once, the display unit 100 automatically rotates by a fixed angle, for example, 5° to 30°.

This embodiment is applicable to a display or television. The television (i.e., the electronic device 400) includes a display unit (i.e., the display unit 100). The display unit, movably connected to the base unit (i.e., the base unit 200), includes a screen (i.e., the screen 101). At least one capacitive or resistive touch sensor (i.e., the sensor 10) is embedded in the housing surface of the screen, and a rotary motor (i.e., the rotary motor 20) is disposed in the base unit. When touched by hand or by other objects, the sensor 10 on the screen housing transmits the received user instruction to a microprocessor in the television, and thus the microprocessor controls the rotary motor to operate. The rotary motor drives the display unit to perform horizontal or vertical rotation with the base unit as a support. Therefore, the angle of the television can be easily adjusted through the electronic device, and meanwhile, the additional expense for purchasing the swivel mount can be saved to further reduce the cost.

In addition, the electronic device of the present invention is not limited to the aforementioned display or television, and may also be other electronic devices including a display unit, for example, projectors. Meanwhile, the base unit may be disposed above the display unit so as to support the display unit on a horizontal plane, and the display unit rotates by touch or receiving a wireless signal.

What is claimed is:

1. An electronic device, comprising:
a base unit;
a display unit, movably connected to the base unit;
at least one sensor, located on the display unit, for receiving and transmitting a signal; and
at least one rotary motor, located in the base unit, for driving the display unit to perform at least one rotation action with the base unit as a support according to the signal.

2. The electronic device according to claim 1, further comprising a signal transmitter for transmitting the signal, wherein the signal is a wireless signal.

3. The electronic device according to claim 1, wherein the at least one sensor comprises a touch sensor, for being touched to generate the touch signal, wherein the signal is a touch signal.

4. The electronic device according to claim 3, wherein the at least one sensor is located on the display unit and disposed in a rotation direction of the display unit, for controlling the at least one rotary motor to drive the electronic device to rotate in the rotation direction after receiving and transmitting the touch signal.

5. The electronic device according to claim 1, wherein the display unit comprises a screen, and the at least one sensor is disposed on at least one of one side of the screen and one side surface of the display unit.

6. The electronic device according to claim 1, wherein the at least one rotary motor is located in the base unit, for controlling the display unit to perform a horizontal rotation with the base unit as a rotation axis, and a rotation angle thereof is in a range of 0° to 180°.

7. The electronic device according to claim 1, wherein the at least one rotary motor is located in the base unit, for controlling the display unit to perform a vertical rotation with the base unit as a support, and a rotation angle thereof is in a range of 0° to 180°.

8. The electronic device according to claim 7, wherein the display unit comprises a screen, and the vertical rotation comprises rotating about a first direction vertical to the screen as a rotation axis.

9. The electronic device according to claim 7, wherein the display unit comprises a screen, and the vertical rotation comprises rotating about a second direction parallel to the screen as a rotation axis.

10. The electronic device according to claim 1, wherein the at least one rotary motor drives the display unit to rotate at intervals with the base unit as a support according to the signal.

11. The electronic device according to claim 1, wherein the at least one rotary motor drives the display unit to rotate continuously with the base unit as a support according to the signal.

12. The electronic device according to claim 1, further comprising a microprocessor, electrically connected to the at least one sensor and the rotary motor, for receiving the signal and controlling the at least one rotary motor to drive the display unit to perform the at least one rotation action.

13. The electronic device according to claim 1, wherein the electronic device is a display, a television, or a projector.

14. An electronic device, comprising:
a base unit;
an electronic member, movably connected to the base unit;
at least one touch sensor, located on a surface of the electronic member, for being touched to generate a user instruction; and
at least one rotary motor, located in the base unit, for driving the electronic member to rotate with the base unit as a support in a single direction according to the user instruction.

15. The electronic device according to claim 14, wherein the at least one touch sensor is disposed in a rotation direction of the electronic member, for controlling the at least one rotary motor to drive the electronic member to rotate in the rotation direction after receiving and transmitting the user instruction.

16. The electronic device according to claim 14, wherein the electronic member comprises a screen, and at least one of the at least one touch sensor is disposed on one side of the screen and the at least one touch sensor is disposed on one side surface of the electronic member.

17. The electronic device according to claim 14, wherein the at least one rotary motor is located in the base unit, for controlling the electronic member to perform at least one of a horizontal rotation and a vertical rotation with the base unit as a rotation axis, and a rotation angle thereof is in a range of 0° to 180°.

18. The electronic device according to claim 17, wherein the electronic member comprises a screen, and the vertical rotation comprises rotating about a first direction vertical to the screen as a rotation axis.

19. The electronic device according to claim 17, wherein the electronic member comprises a screen, and the vertical rotation comprises rotating about a second direction parallel to the screen as a rotation axis.

20. The electronic device according to claim 14, wherein the rotation action comprises:
when the touch sensor receives the user instruction for the first time, the rotary motor drives the electronic member to rotate in a first direction; and
when the touch sensor receives the user instruction for the second time, the rotary motor drives the electronic member to rotate in a second direction opposite to the first direction.

21. The electronic device according to claim 14, wherein the electronic device is a display, a television, or a projector.
